(19) United States
(12) Patent Application Publication
(10) Pub. No.: US 2020/0035270 A1
(43) Pub. Date: Jan. 30, 2020

(54) IMAGE PROCESSING APPARATUS AND IMAGE PROCESSING METHOD

(71) Applicant: SONY CORPORATION, TOKYO (JP)

(72) Inventor: CHIHIRO FUKIAGE, KANAGAWA (JP)

(21) Appl. No.: 16/491,230

(22) PCT Filed: Mar. 19, 2018
(86) PCT No.: PCT/JP2018/010693

§ 371 Date: Sep. 5, 2019

(30) Foreign Application Priority Data
Mar. 27, 2017 (JP) 2017-061084

(51) Int. Cl. G11B 27/02; H04N 5/765; H04N 7/025; H04N 5/92

(52) U.S. Cl. CPC G11B 27/02; H04N 5/9206; H04N 7/025; H04N 5/765

(57) ABSTRACT

To enable easy recognition of an attention point on an image of an attention frame at the time of editing image content. Moving image data is recorded on a recording medium. Electronic mark data including position information indicating a specific position on an image is further recorded on the recording medium in association with a specific frame of the moving image data. For example, the electronic mark data includes text data and further mark type data. For example, monitoring image data corresponding to the moving image data is transmitted to an external device (for example, an imaging monitoring device) and electronic mark provision operation information including position information is received from the external device.

### TECHNICAL FIELD

The present technology relates to an image processing apparatus and an image processing method, and more particularly to an image processing apparatus and the like that enable recording of an electronic mark in association with a specific frame of moving image data.

### BACKGROUND ART

Conventionally, for example, Patent Document 1 describes recording of electronic mark data on a recording medium in association with a specific frame of moving image data recorded on the recording medium, and the electronic mark data includes text data.

In the present technology, a frame to be paid attention can be known from the recording of the electronic mark data, but where in the frame image an attention point is present cannot be easily known. In recent years, since the resolution of image (video) content is increasing, quickly knowing where on an image should be paid attention is required for improvement of editing efficiency.

Furthermore, in the present technology, since text data is associated only with frame information, the application is limited, and the advantage of being able to set arbitrary text data is not utilized. Furthermore, in the present technology, setting of the electronic mark data in each device and a mechanism for sharing a setting value are insufficient.

### CITATION LIST

### Patent Document

### Patent Document 1: Japanese Patent Application Laid-Open No. 2003-299010

### SUMMARY OF THE INVENTION

### Problems to be Solved by the Invention

An object of the present technology enables easy recognition of an attention point on an image of an attention frame at the time of editing image content.

### Solutions to Problems

The concept of the present technology is

an image processing apparatus including:

a recording unit configured to record moving image data on a recording medium, in which

the recording unit further records, on the recording medium, electronic mark data including position information indicating a specific position on an image in association with a specific frame of the moving image data.

In the present technology, the moving image data is recorded on the recording medium by the recording unit. Moreover, by the recording unit, the electronic mark data including position information indicating a specific position on an image is recorded on the recording medium in association with the specific frame of the moving image data. For example, the electronic mark data may include text data. Furthermore, for example, the electronic mark data may include mark type data. Furthermore, for example, the electronic mark data may include frame information indicating the specific frame.

For example, the recording unit may record, corresponding to each piece of clip data each including a predetermined length of moving image data, a set of a predetermined number of electronic mark data related to the clip data, on the recording medium. In this case, for example, the set of a predetermined number of electronic mark data is created as XML data.

According to the present technology as described above, the position information indicating the specific position on the image is included in the electronic mark data recorded on the recording medium in association with the specific frame of the moving image data. Therefore, an attention point on an image of an attention frame can be easily recognized at the time of editing of image content, and the work efficiency of an editor can be improved.

Furthermore, since the mark type data is included in the electronic mark data, the electronic mark data can be used in a wide range of applications such as identification of a person or a building and extraction of an object related to a copyright or a trademark in an image scene, as well as a characteristic, an imaging location, or imaging date and time of an image scene.

Note that, in the present technology, for example, a transmission unit configured to transmit monitoring image data corresponding to the moving image data to an external device (for example, an imaging monitoring device), and a reception unit configured to receive electronic mark provision operation information including the position information from the external device may be further included, and the recording unit may record the electronic mark data in association with the specific frame of the moving image data corresponding to reception timing of the electronic mark provision operation information.

Furthermore, in the present technology, for example, an imaging unit, and an imaging signal processing unit configured to process an imaging signal obtained by the imaging unit to obtain the moving image data may be further included. Furthermore, in the present technology, for example, a transmission unit configured to take out the electronic mark data together with the moving image data from the recording medium and transmit the electronic mark data and the moving image data to an external device may be further included.

Furthermore, another concept of the present technology resides in

an image processing apparatus including:

a reception unit configured to receive monitoring image data from an external device;

a display unit configured to display a screen having an image display area for displaying an image by the monitoring image data;

an operation unit by which a user specifies a specific position on an image displayed in the image display area and performs an electronic mark provision operation; and

a transmission unit configured to transmit electronic mark provision operation information to which position information indicating the specific position is added, to the external device, when the electronic mark provision operation is performed.

In the present technology, the reception unit receives the monitoring image data from the external device (for example, a camera). The display unit displays the screen having an image display area for displaying an image by the monitoring image data. The user performs the electronic mark provision operation by the operation of the operation unit. In this case, the specific position on the image displayed in the image display area is specified.

For example, the display unit may perform electronic mark provision display at a position corresponding to the specific position on the image displayed in the image display area when the electronic mark provision operation is performed. In this case, for example, the electronic mark may be a text mark, and the display unit may perform text display as the electronic mark provision display. Furthermore, in this case, for example, the display unit may display the electronic mark provision display in a mode according to an electronic mark type. Thereby, the user can easily confirm what kind of electronic mark has been given using which position on the image as the attention point.

When the electronic mark provision operation is performed, the transmission unit transmits the electronic mark provision operation information to which the position information indicating the specific position on the image is added to the external device. The external device records the electronic mark data in association with the specific frame of the moving image data corresponding to reception timing of the electronic mark provision operation information.

According to the present technology, as described above, the electronic mark provision operation information to which the position information indicating the specific position on the image is added is transmitted to the external device in response to the operation of the user. Therefore, the external device can record the electronic mark data including the position information indicating the specific position on the image in association with the specific frame of the moving image data corresponding to the reception timing of the electronic mark provision operation information.

Note that, in the present technology, for example, the screen may further have an electronic mark presentation area for presenting an electronic mark selection candidate, and the user may be allowed to select an electronic mark to be provided in the electronic mark presentation area. In this case, the user can easily select the electronic mark to be provided.

In this case, for example, a template reception unit configured to receive information of the electronic mark selection candidate presented in the electronic mark presentation area from the external device as a template may be further included. In this case, the electronic mark selection candidates can be easily set, and furthermore, the electronic mark selection candidates can be shared with another device.

Furthermore, another concept of the present technology resides in

an image processing apparatus for editing moving image data,
electronic mark data being added to the moving image data in association with a specific frame of the moving image data, the electronic mark data including position information indicating a specific position on an image,
the image processing apparatus including:
a display unit configured to display a screen having an image display area for displaying an image by the moving image data, in which
the display unit performs, corresponding to image display of the specific frame in the image display area, electronic mark provision display at the specific position on the image.

The present technology is the image processing apparatus that edits moving image data. The electronic mark data including position information indicating a specific position on an image is added to moving image data in association with the specific frame of the moving image data.

The display unit displays the screen having an image display area for displaying an image by the moving image data. Then, the electronic mark provision display is performed at the position corresponding to the specific position on the image, corresponding to image display of the specific frame in the image display area. For example, the electronic mark may be a text mark, and the display unit may perform text display as the electronic mark provision display. Furthermore, for example, the display unit may display the electronic mark provision display in a mode according to an electronic mark type.

According to the present technology as described above, the electronic mark provision display is performed at the specific position on the image, corresponding to the image display of the specific frame in the image display area. Therefore, the attention point on the image of the attention frame can be easily recognized at the time of editing of image content, and the work efficiency of the editor can be improved.

Note that, in the present technology, for example, an operation unit by which a user performs correction of electronic mark data added to the moving image data, deletes the electronic mark data added to the moving image data, or adds new electronic mark data to the moving image data may be further included.

### Effects of the Invention

According to the present technology, the attention point on the image of the attention frame can be easily recognized at the time of editing of image content. Note that the effects described in the present specification are merely examples and are not limited, and additional effects may be exhibited.

### BRIEF DESCRIPTION OF DRAWINGS

FIG. 1 is a block diagram illustrating a configuration example of an imaging and editing system as an embodiment.

FIG. 2 is a block diagram illustrating a configuration example of a camera.

FIG. 3 is a diagram illustrating an example of an XML format of a set of electronic mark data.

FIG. 4 is a block diagram illustrating a configuration example of an imaging monitoring device.

FIG. 5 is a diagram illustrating an example of a display screen (UI screen) of the imaging monitoring device.

FIG. 6 is a block diagram illustrating a configuration example of an editor terminal device.

FIG. 7 is a diagram illustrating an example of a display screen (UI screen) of the editor terminal device.

### MODE FOR CARRYING OUT THE INVENTION

Hereinafter, a mode for implementing the present invention (hereinafter referred to as an “embodiment”) will be described. Note that the description will be given in the following order.

1. Embodiment

2. Modification

### 1. Embodiment

### [Configuration Example of Imaging and Editing System]

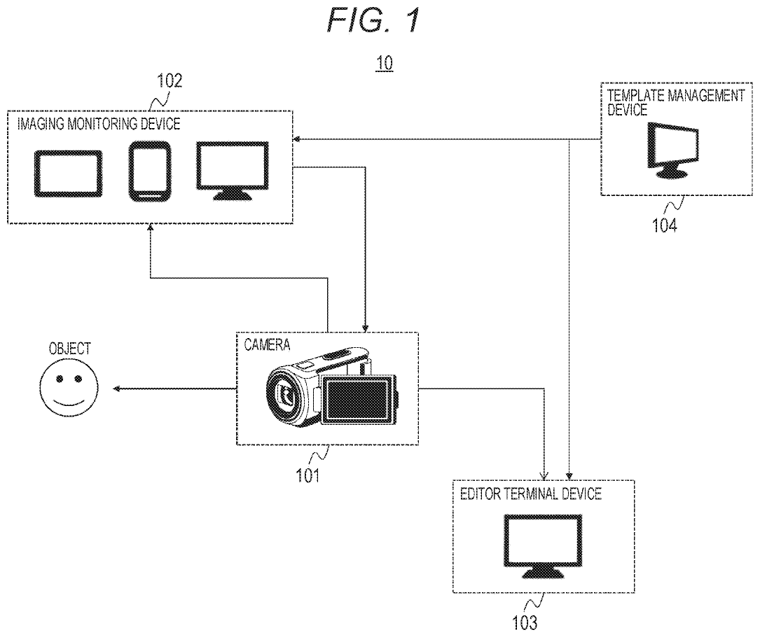

FIG. 1 illustrates a configuration example of an imaging and editing system 10 as an embodiment. The imaging and editing system 10 includes a camera 101, an imaging monitoring device 102, an editor terminal device 103, and a template management device 104.

The camera 101 captures an image of an object to obtain image data, and records the image data on a recording medium such as a memory card. A series of image data from the start to the end of recording is recorded as one clip data (Clip). In the recording medium, the image data is filed for each clip and managed by a file system.

Furthermore, the camera 101 generates monitoring image data on the basis of the image data obtained by imaging, and transmits the monitoring image data to the imaging monitoring device 102 via a network, for example, a wireless network such as Wi-Fi or a wired network. The monitoring image data is smaller in size than the original image data to suppress a transfer bit rate to a low transfer bit rate.

The imaging monitoring device 102 includes, for example, a terminal device such as a smartphone, a tablet, or a personal computer, for example. The imaging monitoring device 102 receives the monitoring image data sent from the camera 101 via the network. Then, the imaging monitoring device 102 displays a screen having an image display area for displaying an image by the monitoring image data on a display unit. Note that the imaging monitoring device 102 does not necessarily need to have the display unit as a physically integrated unit.

In the imaging monitoring device 102, a user (operator) can perform electronic mark provision operation. Note that it can be considered that an electronic mark is a simple mark not including text data in the data. However, in this embodiment, it is assumed that the electronic mark includes text data in the data and further includes mark type data.

As the electronic mark provision operation, the user specifies an attention point on an image displayed in the image display area as a specific position at a specific frame to be paid attention. Here, the number of electronic marks to be provided may be one. In this embodiment, the user can select an electronic mark to be provided from electronic mark selection candidates.

Therefore, the imaging monitoring device 102 causes the screen displayed on the display unit to have an electronic mark presentation area for presenting the electronic mark selection candidates in addition to the above-described image display area. The user selects an electronic mark to be provided in the electronic mark presentation area and then performs the above-described electronic mark provision operation. By enabling selection of the electronic mark to be provided as described above, the user can provide an electronic mark having appropriate text data.

The imaging monitoring device 102 receives a template of information of the electronic mark selection candidates to be presented in the electronic mark presentation area from the template management device 104 connected via the network such as the Internet. In this case, the imaging monitoring device 102 accesses the template management device 104 and receives a desired template from a plurality of types of templates. The imaging monitoring device 102 sets selectable electronic marks on the basis of the template received from the template management device 104, and presents the selectable electronic marks in the electronic mark presentation area on the screen. As described above, the imaging monitoring device 102 receives the template from the template management device 104 and sets the selectable electronic marks before the start of imaging by the camera 101.

By thus having the configuration to receive the information of the electronic mark selection candidate as the template from the template management device 104, the imaging monitoring device 102 can easily set the electronic mark selection candidates and can share the electronic mark selection candidates with another device.

When there is an electronic mark provision operation by the user, the imaging monitoring device 102 performs electronic mark provision display at a position corresponding to the specific position specified as the attention point by the user, as described above, on the image displayed in the image display area on the screen. In this embodiment, text display by the text data included as the data of the electronic mark selected as the electronic mark to be provided by the user is performed in a mode according to the mark type, for example, color, shape, or the like. By performing the electronic mark provision operation in this manner, the user can easily confirm what kind of electronic mark has been provided using which position on the image as the attention point by the user's own electronic mark provision operation.

The imaging monitoring device 102 transmits electronic mark provision operation information to the camera 101 via the network when there is an electronic mark provision operation by the user. Position information indicating the specific position specified as the attention point by the user, as described above, and electronic mark information (the text data and the mark type data) are added to the electronic mark provision operation information. In this case, the position information is data indicating an absolute position or a relative position. In the case of the data indicating an absolute position, the specific position is expressed by pixel coordinate data at the resolution of moving image data handled by the camera 101, for example. On the other hand, in the case of the data indicating a relative position, the specific position is expressed by, for example, ratios where the entire pixels in a horizontal direction and in a vertical direction are 100%, respectively. In this embodiment, it is assumed that the position information is absolute position data.

The camera 101 receives the electronic mark provision operation information sent from the imaging monitoring device 102 via the network. The camera 101 records electronic mark data on the recording medium in association with the specific frame of the moving image data corresponding to reception timing of the electronic mark provision operation information. In this embodiment, the electronic mark data includes frame information indicating the specific frame, the position information and the electronic mark information (the text data and the mark type data) added to the electronic mark provision operation information, and the like.

For example, the camera 101 records, in association with each clip data, a set of a predetermined number of electronic mark data related to the clip data as clip metadata on the recording medium. Therefore, for example, the frame information indicating the specific frame is a frame count number from the beginning of a plurality of pieces of frame image data constituting the clip data.

Furthermore, the camera 101 takes out the electronic mark data recorded on the recording medium together with and in association with the clip data (moving image data), and transfers the electronic mark data via the network, for example, the wireless network such as Wi-Fi or the wired network, the Internet, or the like. This transfer is performed by a manual operation by the user or automatically performed, for example, when the editor terminal device 103 is connected to the camera 101 via the network.

The editor terminal device 103 receives the clip data and the electronic mark data corresponding to the clip data sent from the camera 101 via the network. The editor terminal device 103 displays the screen having the image display area for displaying an image by the clip data on the display unit. In this case, electronic mark provision display (icon display) is performed at a position corresponding to the specific position on the image, corresponding to image display of the specific frame regarding electronic mark provision to the image display area, on the basis of the electronic mark data. The mode of the electronic mark provision display is similar to the electronic mark provision display in the above-described imaging monitoring device 102. In this case, the electronic mark provision display is continuously performed in a vicinity of the specific frame, in other words, in a fixed period including the specific frame.

With the electronic mark provision display, as described above, the user (editor) can easily recognize the attention point on the image of an attention frame at the time of editing image content, and work efficiency can be improved.

Furthermore, in the editor terminal device 103, the user can perform correction of the electronic mark data added in the clip data, deletion of the electronic mark data added in the clip data, or addition of new electronic mark data to the clip data. Therefore, the editor terminal device 103 causes the screen displayed on the display unit to have an electronic mark data presentation area for presenting the information of the electronic mark data added in the clip data. The user can correct or delete the electronic mark data on the basis of presented content in the electronic mark data presentation area.

Furthermore, the editor terminal device 103 causes the screen displayed on the display unit to have the electronic mark presentation area for presenting the electronic mark selection candidates. The user can select the electronic mark to be provided in the electronic mark presentation area and then perform an electronic mark provision operation, as in the above-described imaging monitoring device 102.

The editor terminal device 103 receives a template of information of the electronic mark selection candidates to be presented in the electronic mark presentation area from the template management device 104 connected via the network such as the Internet. In this case, the editor terminal device 103 access the template management device 104, and receives a desired template, for example, the template used in the imaging monitoring device 102 at the time of generating the clip data to be edited, from a plurality of types of templates. The editor terminal device 103 sets selectable electronic marks on the basis of the template received from the template management device 104, and presents the selectable electronic marks in the electronic mark presentation area on the screen.

By having the configuration to receive the template of the information of the electronic mark selection candidates from the template management device 104, the editor terminal device 103 can easily set the electronic mark selection candidates and can share the electronic mark selection candidates with another device, for example, the imaging monitoring device 102.

[Configuration Example of Camera]

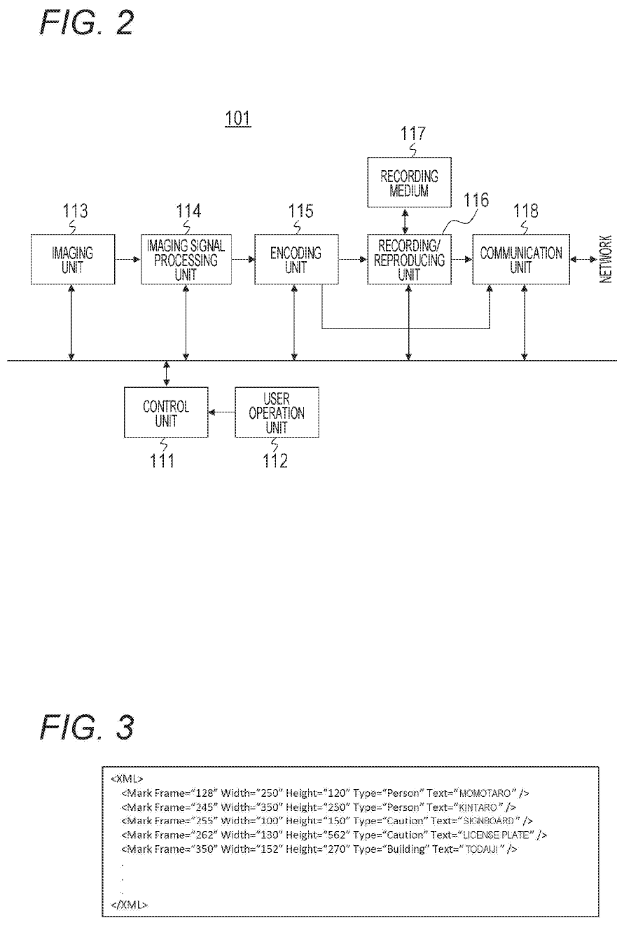

FIG. 2 illustrates a configuration example of the camera 101. The camera 101 includes a control unit 111, a user operation unit 112, an imaging unit 113, an imaging signal processing unit 114, an encoding unit 115, a recording/reproducing unit 116, a recording medium 117, and a communication unit 118.

The control unit 111 controls the operation of each unit of the camera 101. The user operation unit 112 is connected to the control unit 111, and configures a user interface that receives various operations by the user.

The imaging unit 113 includes an imaging lens and an imaging element (imager) (not illustrated), captures an image of an object, and outputs an imaging signal. The imaging element is an imaging element such as a charge coupled device (CCD) or a complementary metal-oxide semiconductor (CMOS). The imaging signal processing unit 114 performs sample hold and gain control, conversion from an analog signal to a digital signal, white balance adjustment, gamma correction, and the like, for the imaging signal (analog signal) output from the imaging unit 113 to generate captured image data.

The encoding unit 115 performs data compression processing by, for example, an MPEG method, for the captured image data generated by the imaging signal processing unit 114 to generate encoded image data. Furthermore, the encoding unit 115 generates monitoring image data on the basis of the captured image data. The monitoring image data is smaller in size than the captured image data to suppress the transfer bit rate to a low transfer bit rate.

The recording/reproducing unit 116 records, on the recording medium 117, the encoded image data obtained in the encoding unit 115, and reproduces the encoded image data from the recording medium 117 as needed. The recording medium 117 is configured by a memory card or the like. Here, the series of image data from the start to the end of recording is recorded as one clip data (Clip). In the recording medium, the image data is filed for each clip and managed by a file system.

At the time of imaging, the communication unit 118 sends the monitoring image data obtained in the encoding unit 115 to the imaging monitoring device 102 via the wireless network such as Wi-Fi or the wired network. The communication unit 118 communicates with the editor terminal device 103 and sends the reproduced clip data and the electronic mark data corresponding to the clip data from the recording medium 117 to the editor terminal device 103.

Furthermore, the communication unit 118 receives the electronic mark provision operation information sent from the imaging monitoring device 102 via the network and sends the information to the control unit 111. The electronic mark provision operation information includes the position information, the electronic mark information (the text data and the mark type data), and the like. The recording/reproducing unit 116 records, on the recording medium 117, the electronic mark data in an XML format, for example, in association with the specific frame of the moving image data corresponding to the reception timing of the electronic mark provision operation information under the control of the control unit 111.

The electronic mark data includes the frame information indicating the specific frame, the position information and the electronic mark information (the text data and the mark type data) added to the electronic mark provision operation information, and the like. For example, the recording/reproducing unit 116 records, in association with each clip data, a set of a predetermined number of electronic mark data related to the clip data as clip metadata on the recording medium 117.

FIG. 3 illustrates an example of an XML format of a set of the electronic mark data. <Mark . . . /> indicates one electronic mark data. “Frame=” indicates the frame information, “Width=” indicates a horizontal position coordinate, “Height=” indicates a vertical position coordinate, “Type=” indicates the mark type, and “Text=” indicates the mark text.

Examples of the mark type include “Person” indicating a person, “Caution” indicating a caution, and “Building” indicating a building. For example, an electronic mark with the mark type of “Person” and the mark text of “Momotaro” is provided by specifying Momotaro existing in an image as the attention point. Furthermore, for example, an electronic mark with the mark type of “Caution” and the mark text of “Signboard” is provided by specifying signboard existing in an image as the attention point.

Furthermore, for example, an electronic mark with the mark type of “Caution” and the mark text of “license plate” is provided by specifying license plate of a car existing in an image as the attention point. Furthermore, for example, an electronic mark with the mark type of “Building” and the mark text of “Todaiji” is provided by specifying Todaiji existing in an image as the attention point.

[Configuration Example of Imaging Monitoring Device]

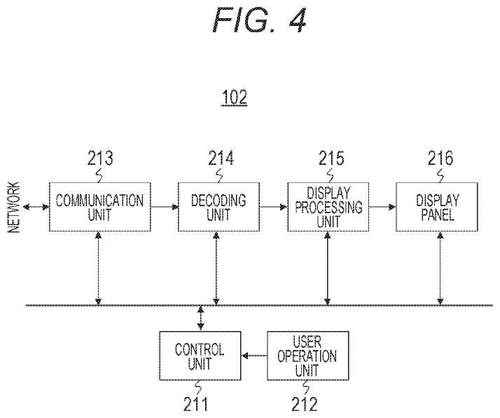

FIG. 4 illustrates a configuration example of the imaging monitoring device 102. The imaging monitoring device 102 includes a control unit 211, a user operation unit 212, a communication unit 213, a decoding unit 214, a display processing unit 215, and a display panel 216.

The control unit 211 controls the operation of each unit of the imaging monitoring device 102. The user operation unit 212 is connected to the control unit 211, and configures a user interface that receives various operations by the user. The user operation unit 212 is configured by, for example, a mechanical operation button, and further, a touch panel disposed on a screen of the display panel 217, and the like.

The communication unit 213 communicates with the camera 101 via the network, and receives the monitoring image data from the camera 101 and transmits electronic mark provision information to the camera 101. Furthermore, the communication unit 213 communicates with the template management device 104 via the network, and receives the template of the information of the electronic mark selection candidates from the template management device 104 via the network.

The decoding unit 214 decodes the monitoring image data (encoded image data) received by the communication unit 213 under the control of the control unit 211. The display processing unit 215 generates display image data for a screen to be displayed on the display panel 216 according to the monitoring image data obtained by the decoding unit 215, the template of the information of the electronic mark selection candidates received by the communication unit 213, an user operation from the user operation unit 212, and the like, under the control of the control unit 211.

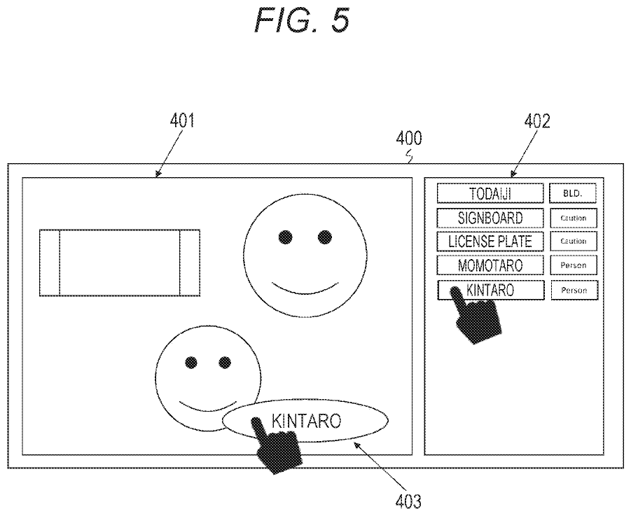

FIG. 5 illustrates an example of a screen (UI screen) 400 to be displayed on the display panel 216. On the screen 400, an image display area 401 for displaying the image by the monitoring image data is present, and an electronic mark presentation area 402 for presenting the electronic mark selection candidates is present. The control unit 211 sets the selectable electronic marks on the basis of the template of the information of the electronic mark selection candidates received by the communication unit 213 and presents the selectable electronic marks in the electronic mark presentation area 402.

In the illustrated example, five electronic mark candidates are presented in the electronic mark presentation area 402. The first electronic mark has the mark text of “Todaiji” and the mark type of “Building”. The second electronic mark has the mark text of “signboard” and the mark type of “Caution”. The third electronic mark has the mark text of “license plate” and the mark type of “Caution”. The fourth electronic mark has the mark text of “Momotaro” and the mark type of “Parson”. The fifth electronic mark has the mark text of “Kintaro” and the mark type of “Parson”.

The user (operator) executes the electronic mark provision operation by reference to the image display area 401 and the electronic mark presentation area 402 on the screen 400. When determining that a frame of the image by the monitoring image data displayed in the image display area 401 is a frame to which an electronic mark should be provided, the user performs the following electronic mark provision operation.

First, the user selects an electronic mark corresponding to an attention object of the image from the electronic mark candidates in the electronic mark presentation area 402 as an electronic mark to be provided by performing an operation of tapping or pushing down a portion of the electronic mark, for example. The illustrated example illustrates a state in which the portion of the fifth electronic mark with the mark text of “Kintaro” and the mark type of “Parson” is pushed down (see the hand mark) to select the fifth electronic mark.

Next, the user taps or pushes down the specific position corresponding to the attention point in the image displayed in the image display area 401 (see the hand mark) to perform the electronic mark provision operation The illustrated example illustrates a state in which a portion of Momotaro in the image displayed in the image display area 401 (see the hand mark) is tapped or pushed down.

At this time, the control unit 211 controls the display processing unit 215 to perform electronic mark provision display 403 at the position tapped or pushed down by the user, in other words, the specific position corresponding to the attention point in the image. In the illustrated example, the text “Kintaro” is displayed in a mode according to the mark type of “Parson”, in this case, in oval.

Furthermore, when the electronic mark provision operation is performed, the communication unit 213 transmits the electronic mark provision operation information to the camera 101 via the network under the control of the control unit 211. The position information indicating the specific position specified as the attention point by the user, and the electronic mark information (the text data and the mark type data) are added to the electronic mark provision operation information.

[Configuration Example of Editor Terminal Device]

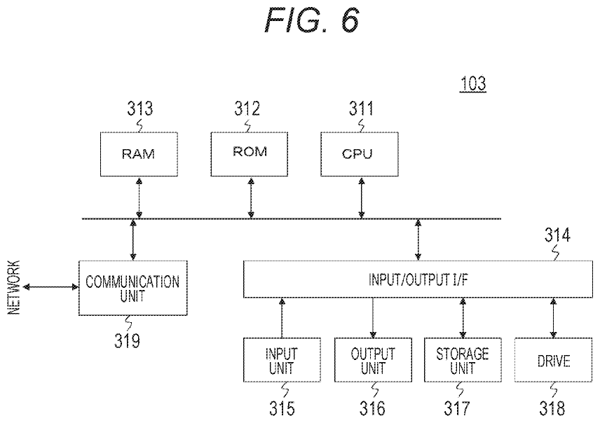

FIG. 6 illustrates a configuration example of the editor terminal device 103. The editor terminal device 103 includes a CPU 311, a ROM 312, a RAM 313, an input/output interface 314, an input unit 315, an output unit 316, a storage unit 317, a drive 318, and a communication unit 319.

In the editor terminal device 103, the CPU 311, the ROM 312, and the RAM 313 are mutually connected by a bus. Moreover, the input/output interface 314 is connected to the bus. The input unit 315, the output unit 316, the storage unit 317, and the drive 318 are connected to the input/output interface 314. The CPU 311 controls the operation of each unit of the editor terminal device 103.

The input unit 315 is configured by a touch panel, a keyboard, a mouse, a microphone, and the like. The output unit 316 is configured by a display, a speaker, and the like. The storage unit 317 is configured by a hard disk drive (HDD), a non-volatile memory, and the like. The drive 318 drives a removable medium such as a magnetic disk, an optical disk, a magneto-optical disk, or a memory card.

Furthermore, the communication unit 319 is connected to the bus. The communication unit 319 communicates with the camera 101 and the template management device 104 via the network. The communication unit 319 communicates with the camera 101 via the network, and receives the electronic mark data recorded together with and in association with the clip data (moving image data). Furthermore, the communication unit 319 communicates with the template management device 104, and receives the template of the information of the electronic mark selection candidates.

The clip data (moving image data) received by the communication unit 319 and the electronic mark data associated with the clip data are stored in the storage unit 317. At the time of editing, the clip data stored in the storage unit 317 is reproduced and encoded by the CPU 311, and an image based on the moving image data is displayed on a display of the output unit 316. In that case, electronic mark provision display (icon display) is performed at the specific position on the image, corresponding to image display of the specific frame regarding electronic mark provision on the basis of the electronic mark data under the control of the CPU 311. In this case, the electronic mark provision display is continuously performed in a vicinity of the specific frame, in other words, in a fixed period including the specific frame.

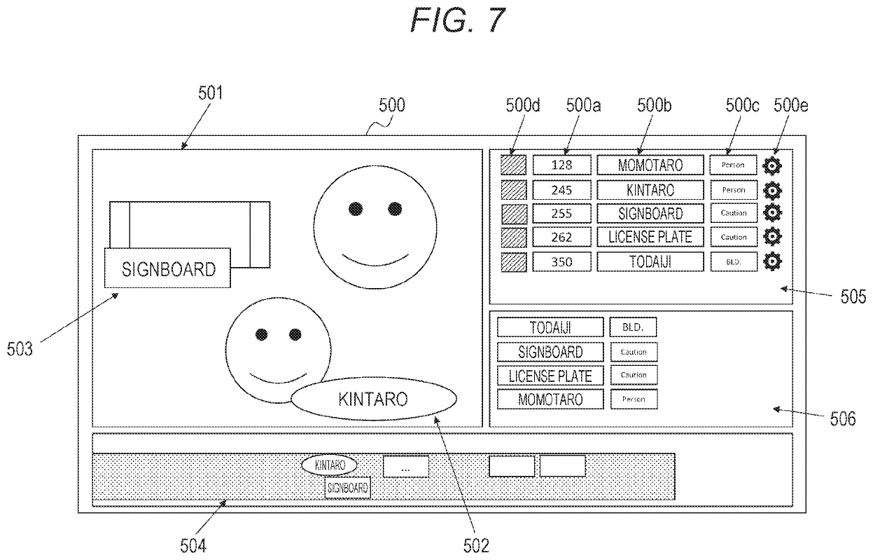

FIG. 7 illustrates an example of a screen (UI screen) 500 to be displayed on a display at the time of editing. On the screen 500, an image display area 501 for displaying an image by moving image data is present. The illustrated example illustrates a state in which electronic mark provision display 502 and 503 is being performed. The electronic mark provision display 502 displays the text “Kintaro” in the mode according to the mark type of “Parson”, in this case, in oval. Furthermore, the electronic mark provision display 503 displays the text “signboard” in a mode according to the mark type of “Caution”, in this case, in square.

A timeline 504 corresponding to moving image data for a fixed time as clip data is present in a lower portion on the screen 500. The electronic mark provision display (icon display) is performed on the timeline 504, corresponding to the frame position to which the electronic mark is provided. In this case, when the user (editor) performs the pushing down operation at a specific position on the timeline 504, thereby seeking the reproduction position in the clip data to a frame position corresponding to the specific position.

In the editor terminal device 103, the user can perform correction of content of the electronic mark data added in the clip data or deletion of the electronic mark data added in the clip data, as described above. For this purpose, the screen 500 has an electronic mark list display area 505 for displaying a list of the electronic mark data added in the clip data.

In this case, data content of each electronic mark is displayed. The illustrated example is an example of a case where the above-described set of electronic mark data illustrated in FIG. 3 is added in the clip data. Frame information 505a, a mark text 505b, and a mark type 505c are displayed corresponding to each electronic mark data, and further, a thumbnail 505d of a frame of the moving image data to which the electronic mark data is added is displayed. When the user (editor) performs the pushing down operation on the display portion of each electronic mark data, thereby seeking the reproduction position in the clip data to a provided frame position of the electronic mark data.

Furthermore, an edit link button 505e is also displayed corresponding to display of each of electronic mark data content. When the user performs the pushing down operation on the edit link button 505e, an edit dialog box (not illustrated) that enables editing of the corresponding electronic mark data content is displayed. The user can correct the content of the frame information 505a, the mark text 505b, and the mark type 505c, further, can change the position information, and furthermore, can delete the electronic mark data, in the edit dialog box. The correction of the electronic mark data content and the deletion of the electronic mark data can be performed in this manner. Therefore, erroneously added electronic mark data can be corrected.

Furthermore, in the editor terminal device 103, the user can perform the electronic mark provision operation for the moving image data, as in the imaging monitoring device 102, as described above. Therefore, an electronic mark presentation area 506 for presenting the electronic mark selection candidates is present on the screen 500. The CPU 311 sets the selectable electronic marks on the basis of the template of the information of the electronic mark selection candidates received by the communication unit 319 and presents the selectable electronic marks in the electronic mark presentation area 506.

The electronic mark provision operation by the user (editor) using the electronic mark presentation area 506 is similar to the above-described electronic mark provision operation in the imaging monitoring device 102. Therefore, detailed description is omitted here.

As described above, in the camera 101 of the imaging and editing system 10 illustrated in FIG. 1, the position information indicating the specific position on the image is included in the electronic mark data recorded on the recording medium 117 in association with the specific frame of the moving image data. Therefore, for example, the editor terminal device 103 can easily recognize the attention point on the image of the attention frame at the time of editing the image content (clip data), and the work efficiency of an editor can be improved.

Furthermore, in the camera 101 of the imaging and editing system 10 illustrated in FIG. 1, the mark type data is also included in addition to the text mark in the electronic mark data recorded on the recording medium 117 in association with the specific frame of the moving image data. Therefore, the electronic mark data can be used in a wide range of applications such as identification of a person or a building and extraction of an object related to a copyright or a trademark in an image scene, as well as a characteristic, an imaging location, or imaging date and time of an image scene.

Furthermore, in the imaging monitoring device 102 of the imaging and editing system 10 illustrated in FIG. 1, when the specific position on the image displayed in the image display area 401 on the screen 400 is specified and the electronic mark provision operation is performed, the electronic mark provision display is performed at the position corresponding to the specific position (see FIG. 5). Therefore, the user (operator) can easily confirm what kind of electronic mark has been given using which position on the image as the attention point.

Furthermore, in the imaging monitoring device 102 of the imaging and editing system 10 illustrated in FIG. 1, the electronic mark provision operation information to which the position information indicating the specific position on the image is added is transmitted to the camera 101 in response to the electronic mark provision operation of the user. Therefore, the camera 101 can record the electronic mark data including the position information indicating the specific position on the image in association with the specific frame of the moving image data corresponding to the reception timing of the electronic mark provision operation information.

Furthermore, in the imaging monitoring device 102 of the imaging and editing system 10 illustrated in FIG. 1, the screen 400 has the electronic mark presentation area 402 for presenting the electronic mark selection candidates (see FIG. 5). Therefore, the user can easily select an electronic mark to be provided by using the electronic mark presentation area 402.

Furthermore, in the imaging monitoring device 102 and the editor terminal device 103 of the imaging and editing system 10 illustrated in FIG. 1, the information of the electronic mark selection candidates presented in the electronic mark presentation area 402 or 506 (see FIG. 5 or 7) is received as the template from the template management device 104. Therefore, the electronic mark selection candidates can be easily set, and furthermore, the electronic mark selection candidates can be shared with another device.

Furthermore, in the editor terminal device 103 of the imaging and editing system 10 illustrated in FIG. 1, the electronic mark provision display is performed at the specific position on the image, corresponding to the image display of the specific frame in the image display area 501 on the screen 500 (see the electronic mark provision display 502 and 503 in FIG. 7). Therefore, the attention point on the image of the attention frame can be easily recognized at the time of editing of image content, and the work efficiency of the editor can be improved.

Furthermore, in the editor terminal device 103 of the imaging and editing system 10 illustrated in FIG. 1, the screen 500 has the electronic mark list display area 505 for displaying a list of electronic mark data added in the clip data. Therefore, the user (editor) can easily confirm the content of the electronic mark data added in the clip data, and can correct the electronic mark data content or delete the electronic mark data, as needed.

Furthermore, the thumbnail 505d of the added frame is displayed together with the content of each electronic mark data. Therefore, the user (editor) can easily recognize which frame image the electronic mark data is added corresponding to, and the work efficiency of the editor can be improved. Furthermore, in the above-described embodiment, the electronic mark data is recorded as the clip metadata, and the frame information is included in the electronic mark data. However, it is also conceivable that the frame information is not included in a case where each electronic mark data is recorded as frame metadata.

### 2. Modification

Note that, in the above-described embodiment, an example in which the camera 101 includes the recording/reproducing unit has been illustrated. However, it is also conceivable that an imaging portion and a recording/reproducing portion are physically separately configured. Furthermore, the mark text and the mark type in the above-described embodiment are merely an example, and the present invention is not limited to the example. Furthermore, in the above-described embodiment, the description has been given such that the electronic mark provision operation in the imaging monitoring device 102 is performed using the touch panel. However, another user operation means, for example, a mouse or the like can also be used.

Furthermore, the present technology can also have the following configurations.

(1) An image processing apparatus including:

a recording unit configured to record moving image data on a recording medium, in which

the recording unit further records, on the recording medium, electronic mark data including position information indicating a specific position on an image in association with a specific frame of the moving image data.

(2) The image processing apparatus according to (1), in which

the electronic mark data includes text data.

(3) The image processing apparatus according to (1) or (2), in which

the electronic mark data includes mark type data.

(4) The image processing apparatus according to any one of (1) to (3), in which

the electronic mark data includes frame information indicating the specific frame.

(5) The image processing apparatus according to any one of (1) to (4), further including:

a transmission unit configured to transmit monitoring image data corresponding to the moving image data to an external device; and

a reception unit configured to receive electronic mark provision operation information including the position information from the external device, in which

the recording unit records the electronic mark data in association with the specific frame of the moving image data corresponding to reception timing of the electronic mark provision operation information.

(6) The image processing apparatus according to any one of (1) to (5), further including:

an imaging unit; and

an imaging signal processing unit configured to process an imaging signal obtained by the imaging unit to obtain the moving image data.

(7) The image processing apparatus according to any one of (1) to (6), further including:

a transmission unit configured to take out the electronic mark data together with the moving image data from the recording medium and transmit the electronic mark data and the moving image data to an external device.

(8) The image processing apparatus according to any one of (1) to (7), in which

the recording unit

records, corresponding to each piece of clip data each including a predetermined length of moving image data, a set of a predetermined number of electronic mark data related to the clip data, on the recording medium.

(9) An image processing method including:

a step of recording moving image data on a recording medium; and

a step of recording, on the recording medium, electronic mark data including position information indicating a specific position on an image in association with a specific frame of the moving image data.

(10) An image processing apparatus including:

a reception unit configured to receive monitoring image data from an external device;

a display unit configured to display a screen having an image display area for displaying an image by the monitoring image data;

an operation unit by which a user specifies a specific position on an image displayed in the image display area and performs an electronic mark provision operation; and

a transmission unit configured to transmit electronic mark provision operation information to which position information indicating the specific position is added, to the external device, when the electronic mark provision operation is performed.

(11) The image processing apparatus according to (10), in which

the screen further has an electronic mark presentation area for presenting an electronic mark selection candidate, and

the user selects an electronic mark to be provided in the electronic mark presentation area.

(12) The image processing apparatus according to (11), further including:

a template reception unit configured to receive information of the electronic mark selection candidate presented in the electronic mark presentation area from the external device as a template.

(13) The image processing apparatus according to (10) or (11), in which

the display unit performs electronic mark provision display at a position corresponding to the specific position on the image displayed in the image display area when the electronic mark provision operation is performed.

(14) The image processing apparatus according to (13), in which

the electronic mark is a text mark, and the display unit performs text display as the electronic mark provision display.

(15) The image processing apparatus according to (13) or (14), in which

the display unit displays the electronic mark provision display in a mode according to an electronic mark type.

(16) An image processing method including:

a reception step of receiving monitoring image data from an external device;

a display step of displaying a screen having an image display area for displaying an image by the monitoring image data; and

a transmission step of transmitting, when a user specifies a specific position on an image displayed in the image display area and performs an electronic mark provision operation, electronic mark provision operation information to which position information indicating the specific position is added, to the external device.

(17) An image processing apparatus for editing moving image data,

electronic mark data being added to the moving image data in association with a specific frame of the moving image data, the electronic mark data including position information indicating a specific position on an image,

the image processing apparatus including:

a display unit configured to display a screen having an image display area for displaying an image by the moving image data, in which

the display unit performs, corresponding to image display of the specific frame in the image display area, electronic mark provision display at a position corresponding to the specific position on the image.

(18) The image processing apparatus according to (17), in which

the electronic mark is a text mark, and the display unit performs text display as the electronic mark provision display.

(19) The image processing apparatus according to (17) or (18), in which

the display unit displays the electronic mark provision display in a mode according to an electronic mark type.

(20) The image processing apparatus according to any one of (17) to (19), further including:

an operation unit by which a user performs correction of electronic mark data added to the moving image data, deletes the electronic mark data added to the moving image data, or adds new electronic mark data to the moving image data.

### REFERENCE SIGNS LIST

10 Imaging and editing system
101 Camera
102 Imaging monitoring device
103 Editor terminal device
104 Template management device
111 Control unit
112 User operation unit
113 Imaging unit
114 Imaging signal processing unit
115 Encoding unit
116 Recording/reproducing unit
117 Recoding medium
118 Communication unit
211 Control unit
212 User operation unit
213 Communication unit
214 Decoding unit
215 Display processing unit
216 Display panel
311 CPU
312 ROM
313 RAM
314 Input/output interface
315 Input unit
316 Output unit
317 Storage unit
318 Drive
319 Communication unit
400 Screen
401 Image display area
402 Electronic mark presentation area
403 Electronic mark provision display
500 Screen
501 Image display area
502, 503 Electronic mark provision display
504 Timeline
505 Electronic mark list display area
505a Frame information
505b Mark text
505c Mark type
505d Thumbnail
505e Edit link button
506 Electronic mark presentation area

1. An image processing apparatus comprising:
a recording unit configured to record moving image data on a recording medium, wherein
the recording unit further records, on the recording medium, electronic mark data including position information indicating a specific position on an image in association with a specific frame of the moving image data.

2. The image processing apparatus according to claim 1, wherein
the electronic mark data includes text data.

3. The image processing apparatus according to claim 1, wherein
the electronic mark data includes mark type data.

4. The image processing apparatus according to claim 1, wherein
the electronic mark data includes frame information indicating the specific frame.

5. The image processing apparatus according to claim 1, further comprising:
a transmission unit configured to transmit monitoring image data corresponding to the moving image data to an external device; and
a reception unit configured to receive electronic mark provision operation information including the position information from the external device, wherein
the recording unit records the electronic mark data in association with the specific frame of the moving image data corresponding to reception timing of the electronic mark provision operation information.

6. The image processing apparatus according to claim 1, further comprising:
an imaging unit; and
an imaging signal processing unit configured to process an imaging signal obtained by the imaging unit to obtain the moving image data.

7. The image processing apparatus according to claim 1, further comprising:
a transmission unit configured to take out the electronic mark data together with the moving image data from the recording medium and transmit the electronic mark data and the moving image data to an external device.

8. The image processing apparatus according to claim 1, wherein
the recording unit
records, corresponding to each piece of clip data each including a predetermined length of moving image data, a set of a predetermined number of electronic mark data related to the clip data, on the recording medium.

9. An image processing method comprising:
a step of recording moving image data on a recording medium; and
a step of recording, on the recording medium, electronic mark data including position information indicating a specific position on an image in association with a specific frame of the moving image data.

10. An image processing apparatus comprising:
a reception unit configured to receive monitoring image data from an external device;
a display unit configured to display a screen having an image display area for displaying an image by the monitoring image data;
an operation unit by which a user specifies a specific position on an image displayed in the image display area and performs an electronic mark provision operation; and
a transmission unit configured to transmit electronic mark provision operation information to which position information indicating the specific position is added, to the external device, when the electronic mark provision operation is performed.

11. The image processing apparatus according to claim 10, wherein
the screen further has an electronic mark presentation area for presenting an electronic mark selection candidate, and
the user selects an electronic mark to be provided in the electronic mark presentation area.

12. The image processing apparatus according to claim 11, further comprising:
a template reception unit configured to receive information of the electronic mark selection candidate presented in the electronic mark presentation area from the external device as a template.

13. The image processing apparatus according to claim 10, wherein
the display unit performs electronic mark provision display at a position corresponding to the specific position on the image displayed in the image display area when the electronic mark provision operation is performed.

14. The image processing apparatus according to claim 13, wherein
the electronic mark is a text mark, and the display unit performs text display as the electronic mark provision display.

15. The image processing apparatus according to claim 13, wherein
the display unit displays the electronic mark provision display in a mode according to an electronic mark type.

16. An image processing method comprising:
a reception step of receiving monitoring image data from an external device;
a display step of displaying a screen having an image display area for displaying an image by the monitoring image data; and
a transmission step of transmitting, when a user specifies a specific position on an image displayed in the image display area and performs an electronic mark provision operation, electronic mark provision operation information to which position information indicating the specific position is added, to the external device.

17. An image processing apparatus for editing moving image data,
electronic mark data being added to the moving image data in association with a specific frame of the moving image data, the electronic mark data including position information indicating a specific position on an image,
the image processing apparatus comprising:
a display unit configured to display a screen having an image display area for displaying an image by the moving image data, wherein
the display unit performs, corresponding to image display of the specific frame in the image display area, electronic mark provision display at a position corresponding to the specific position on the image.

18. The image processing apparatus according to claim 17, wherein
the electronic mark is a text mark, and the display unit performs text display as the electronic mark provision display.

19. The image processing apparatus according to claim 17, wherein
the display unit displays the electronic mark provision display in a mode according to an electronic mark type.

20. The image processing apparatus according to claim 17, further comprising:
an operation unit by which a user performs correction of electronic mark data added to the moving image data, deletes the electronic mark data added to the moving image data, or adds new electronic mark data to the moving image data.
